(19) United States
(12) Patent Application Publication
(10) Pub. No.: US 2010/0206856 A1
(43) Pub. Date: Aug. 19, 2010

(54) LASER WELDING METHOD AND APPARATUS

(75) Inventors: Chikara TANAKA, Hiroshima (JP); Yoichiro KITAHARA, Hiroshima (JP)

Correspondence Address: Studebaker & Brackett PC, One Fountain Square, 11911 Freedom Drive, Suite 750, Reston, VA, 20190, US

(73) Assignee: MAZDA MOTOR CORPORATION, Hiroshima (JP)

(21) Appl. No.: 12/696,796

(22) Filed: Jan. 29, 2010

(30) Foreign Application Priority Data
Feb. 13, 2009 (JP) 2009-030648

(51) Int. Cl. B23K 26/00

(52) U.S. Cl. 219/121.64; 219/121.63

(57) ABSTRACT

A laser welding method including a step of welding upper and lower metal plates, a step of picking up an image of a molten pool near a molten hole from the side of the upper metal plate during an execution of the welding step, a step of determining whether a welding state of the metal plates is proper or not by analyzing a generation state of the molten pool based on the image picked up in the picking-up step, and a step of adjusting at least one of a parameter of the irradiated laser beams and a feeding speed of the filler wire so that the welding state of the metal plates becomes proper in case the welding state determined in the determining step is not proper.

### BACKGROUND OF THE INVENTION

The present invention relates to a laser welding method and apparatus of a pair of flat-plate-shaped metal plates overlapped vertically.

A laser welding has been recently used as a welding method of a pair of flat-plate-shaped metal plates overlapped vertically. In the laser welding, a laser beam is irradiated toward a surface of an upper metal plate so as to move along a welding path in such a manner that a laser-beam irradiated portion of the upper and lower metal plates is molten and a line-shaped welding bead is generated.

Herein, in general, the respective facing faces of the two metal plates are not flat completely, so some clearance between the metal plates is generated. Further, this clearance may not be uniform, so there is a concern that the molten metal of the upper metal plate would not lower to the lower metal plate beyond the above-described clearance at a position where the clearance is relatively large. Consequently, some incomplete welding would occur.

Japanese Patent Laid-Open Publication No. 2006-159234 discloses a technology which may solve the above-described problem, in which a filler wire is fed to the beam-laser irradiated portion such that its tip follows the laser beams irradiated. According to this technology, the filler wire is also molten in addition to the metal plate and thereby the total amount of molten metal is increased. Consequently, the molten metal may lower to the lower metal plate properly beyond the above-described clearance, thereby preventing the above-described incomplete welding.

The above-described publication also discloses a variable control of the feeding amount of filler wire according to the degree of the clearance between the metal plates. Specifically, based on the recognition that the feeding load of filler wire from a filler-wire feeding device depends on the degree of the clearance, the feeding load of filler wire from the filler-wire feeding device is detected and the feeding amount of filler wire is variably controlled according to this feeding load detected. Consequently, the proper welding may be provided despite some change of the clearance (the tolerance of clearance may be improved). Meanwhile, some methods of the welding-state detection are known as described in Japanese Patent Laid-Open Publication Nos. 2002-239731 and 2006-082129, for example.

According to the technology of the above-described publication, however, since it may be necessary that the tip of the filler wire in a non-molten state is inserted into the above-described molten hole or pool sufficiently to detect the feeding load of the filler wire properly, there is a concern that forming a welding bead or the like would deteriorate.

### SUMMARY OF THE INVENTION

An object of the present invention is to provide a laser welding method and apparatus which can provide the proper welding of the flat-plate-shaped metal plates overlapped vertically with the clearance therebetween, without detecting the feeding load of the filler wire.

According to the present invention, there is provided a laser welding method of a pair of flat-plate-shaped metal plates overlapped vertically with a clearance therebetween, comprising a step of welding upper and lower metal plates overlapped with laser beams and a filler wire, in which the laser beams is irradiated toward a surface of the upper metal plate so as to move along a welding path and the filler wire is fed to a laser-beam irradiated portion of the upper metal plate such that a tip thereof follows the laser beams irradiated in such a manner that the laser-beam irradiated portion of the upper metal plate is molten such that a molten hole which penetrates the upper metal plate vertically is generated and the tip of the filler wire is molten, so that a molten pool in which molten metal of the upper metal plate and the filler wire is collected around the molten hole can be generated behind the laser-beam irradiated portion in such a manner that the molten metal of the upper metal plate and the filler wire lowers beyond the clearance between the upper and lower metal plates, a step of picking up an image of the molten pool near the molten hole from the side of the upper metal plate during an execution of the welding step, a step of determining whether a welding state of the upper and lower metal plates is proper or not by analyzing a generation state of the molten pool based on the image picked up in the picking-up step, and a step of adjusting at least one of a parameter of the irradiated laser beams, a relative speed between the irradiated laser beams and the fed filler wire and the metal plates, and a feeding speed of the filler wire so that the welding state of the upper and lower metal plates becomes proper in case the welding state determined in the determining step is not proper.

According to the present invention, since the above-described adjusting step is provided, the welding of the metal plates can be made proper. Further, since the welding state (being proper or improper) of the metal plates is determined by analyzing the generation state of the molten pool based on the picked-up image of the molten pool near the molten hole, the determination can be made accurate. Thus, the proper and high-quality welding can be provided. Herein, in case the above-described image picking-up and determination are repeated in a considerably short cycle, the above-described adjustment can be conducted promptly to correct the improper welding state, thereby improving the welding state.

According to an embodiment of the present invention, it is determined in the determining step that the welding state of the upper and lower metal plates is not proper in case the width of the molten pool which is detected based on the image picked up in the picking-up step is not within a range of twice through fifth times the diameter of the laser beams irradiated on the surface of the upper metal plate. According to the experiments conducted by the inventors of the present invention, it was found that in case the width of the molten pool was less than twice the diameter of the laser beams or greater than fifth times the diameter of the laser beams, the molten metal of the upper metal plate did not lower to (reach) the lower metal plate, so that the proper welding of the upper and lower metal plates could not be provided. Therefore, the above-described adjustment is conducted in case the width of the molten pool is not within the range of twice through fifth times the diameter of the laser beams. Thereby, the welding state can be improved.

According to another embodiment of the present invention, it is determined in the determining step that the welding state of the upper and lower metal plates is not proper in case a ratio which is obtained by dividing the amount of projection of the molten metal in the molten pool over the surface of the upper metal plate by the width of the molten pool is greater than 0.2, the amount of projection of the molten metal in the molten pool and the width of the molten pool being detected based on the image picked up in the picking-up step. The experiments conducted by the inventors of the present invention also showed that in case the ratio obtained by dividing the amount of projection of the molten metal by the width of the molten pool was greater than 0.2, the molten metal of the upper metal plate did not lower to the lower metal plate, so that the proper welding of the upper and lower metal plates could not be provided. Therefore, the above-described adjustment is conducted in case the ratio obtained by dividing the amount of projection of the molten metal by the width of the molten pool was greater than 0.2. Thereby, the welding state can be improved.

According to another aspect of the present invention, there is provided a laser welding apparatus of a pair of flat-plate-shaped metal plates overlapped vertically with a clearance therebetween, comprising means for welding upper and lower metal plates overlapped with laser beams and a filler wire, in which the laser beams is irradiated toward a surface of the upper metal plate so as to move along a welding path and the filler wire is fed to a laser-beam irradiated portion of the upper metal plate such that a tip thereof follows the laser beams irradiated in such a manner that the laser-beam irradiated portion of the upper metal plate is molten such that a molten hole which penetrates the upper metal plate vertically is generated and the tip of the filler wire is molten, so that a molten pool in which molten metal of the upper metal plate and the filler wire is collected around the molten hole can be generated behind the laser-beam irradiated portion in such a manner that the molten metal of the upper metal plate and the filler wire lowers beyond the clearance between the upper and lower metal plates, means for picking up an image of the molten pool near the molten hole from the side of the upper metal plate during a welding execution by the welding means, means for determining whether a welding state of the upper and lower metal plates is proper or not by analyzing a generation state of the molten pool based on the image picked up by the picking-up means, and means for adjusting at least one of a parameter of the irradiated laser beams, a relative speed between the irradiated laser beams and the fed filler wire and the metal plates, and a feeding speed of the filler wire so that the welding state of the upper and lower metal plates becomes proper in case the welding state determined by the determining means is not proper.

The above-described laser welding apparatus according to another aspect of the present invention can provide substantially the same operations and advantages as those of the above-described laser welding method.

Other features, aspects, and advantages of the present invention will become apparent from the following description which refers to the accompanying drawings.

### BRIEF DESCRIPTION OF THE DRAWINGS

FIG. 1 is a perspective view of a laser welding apparatus according to a first embodiment of the present invention.

FIG. 2 is a control constitution diagram of the laser welding apparatus.

FIG. 3 is a photograph showing a section of a welding portion in a proper welding state.

FIG. 4 is an exemplified image of a laser-beam irradiated portion of a metal plate and its vicinity which is picked up by an image picking-up device during a laser welding.

FIG. 5 is a perspective view showing a state of the laser-beam irradiated portion of the metal plate and its vicinity during the laser welding.

FIG. 6A is a plan view showing the state of the laser-beam irradiated portion of the metal plate and its vicinity during the laser welding, and FIG. 6B is a sectional view taken along line A-A of FIG. 6A.

FIG. 7A is a sectional view taken along line B-B of FIG. 6B, FIG. 7B is a sectional view taken along line C-C of FIG. 6B, FIG. 7C is a sectional view taken along line D-D of FIG. 6B, FIG. 7D is a sectional view taken along line E-E of FIG. 6B, FIG. 7E is a sectional view taken along line F-F of FIG. 6B, and FIG. 7F is a sectional view taken along line G-G of FIG. 6B.

FIGS. 8A-F are sectional views in case the welding state is not proper (the width of a molten pool is great), which correspond to FIGS. 7A-7F; specifically, FIG. 8A is a sectional view taken along line K-K of FIG. 9, FIG. 8B is a sectional view taken along line M-M of FIG. 9, FIG. 8C is a sectional view taken along line N-N of FIG. 9, FIG. 8D is a sectional view taken along line P-P of FIG. 9, FIG. 8E is a sectional view taken along line Q-Q of FIG. 9, and FIG. 8F is a sectional view taken along line S-S of FIG. 9.

FIG. 9 is a sectional view in case the welding state is not proper (the width of the molten pool is great), which corresponds to FIG. 6B.

FIGS. 10A-F are sectional views in case the welding state is not proper (the width of the molten pool is small), which correspond to FIGS. 8A-7F.

FIG. 11 is a flowchart showing a welding control by a controller.

FIG. 12 is a photograph in case the welding state is not proper (the width of the molten pool is great), which corresponds to FIG. 4.

FIGS. 13A, B are sectional views explaining an operation of the control in case the width of the molten pool is great.

FIG. 14 is a photograph in case the welding state is not proper (the width of the molten pool is small), which corresponds to FIG. 4.

FIG. 15 is a flowchart showing another welding control by the controller according to second and third embodiments.

FIG. 16 is an explanatory diagram of a detection of the amount of projection of the molten pool.

FIG. 17 is a flowchart showing further another welding control by the controller according to a fourth embodiment.

### DETAILED DESCRIPTION OF THE INVENTION

Hereinafter, a laser welding method and a laser welding apparatus according to preferred embodiments of the present invention will be described.

### Embodiment 1

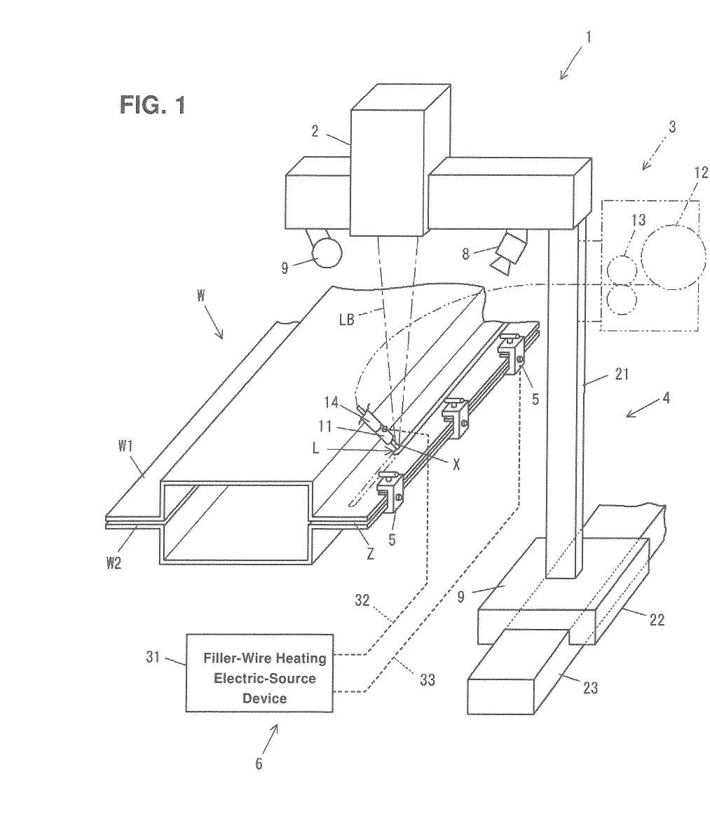

FIG. 1 is a perspective view of a laser welding apparatus 1 according to the present embodiment. The laser welding apparatus 1 comprises a laser head 2 which generates laser beams LB, a filler-wire feeding device 3 which feeds a filler wire X to a laser-beam irradiated portion L from the laser head 2, and a moving device 4 which supports the laser head 2 and the filler-wire feeding device 3 and moves them relatively to work W. Herein, the work W is comprised of upper and lower metal plates W1, W2 which have a U-shaped cross section, respectively, and flanges of which are overlapped, for example. The flanges of the metal plates W1, W2 are clamped with plural clamps 5 . . . 5, however, some clearance Z may be inevitably generated between facing faces of these metal plates W1, W2 due to their manufacturing accuracy.

The laser head 2 is constituted by using a high-power laser, such as YAG laser or carbonic-acid gas laser, and its laser power is configured to be variable. While the focus point of the laser beams is variable, it is set on the surface of the upper metal plate W1 in the present embodiment.

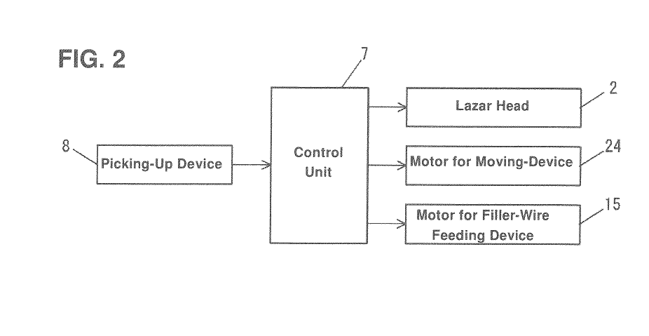

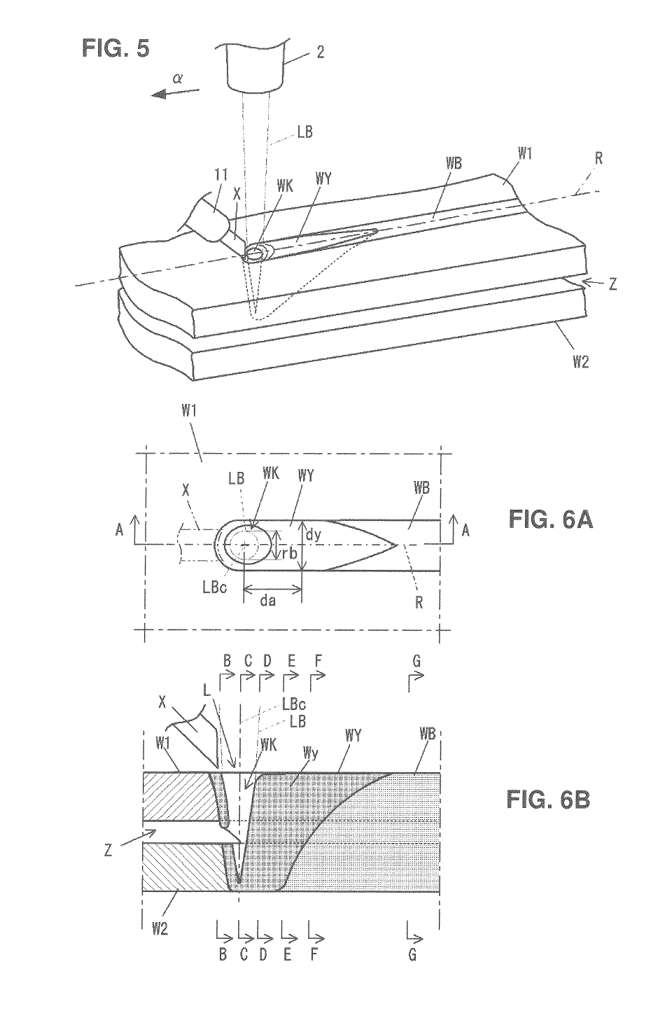

The filler-wire feeding device 3 comprises a wire-feeding nozzle 11 (see FIG. 5) which is arranged in such a manner that its tip is positioned near a front portion of the laser-beam irradiated portion L of the laser beams LB, a wire roll 12 by which the filler wire X is wound up, a providing roller 13 which is driven by a motor 15 (see FIG. 2) and provides the filler wire X from the wire roll 12, and a tube 14 which extends between the providing roller 13 and the wire-feeding nozzle 11 and guides the filler wire X from the providing roller 13 to the wire-feeding nozzle 11. The motor 15 is constituted by a servo motor having its variable rotational speed, so that the feeding amount of the wire X to the laser-beam irradiated portion is configured to be adjustable.

The moving device 4 comprises a support member 21 to which the laser head 2 and the filler-wire feeding device 3 are attached, a stand member 22 which is attached to a lower end of the support member 21, a rail member 23 which is disposed on a floor in a factory or the like and supports the stand member movably, and a moving mechanism (not illustrated) which moves the stand member 12 along the rail member 23. This moving mechanism may be constituted by any known mechanism, so its detailed description will be omitted here. However, its drive source is made of a servo motor 24 (see FIG. 2) having its controllable rotational speed, so that the moving speed of the laser head 11 and the filler-wire feeding device 3 relative to the work W is adjustable.

The laser welding apparatus 1 further comprises a filler-wire heating device 6 which heats the filler wire X. This filler-wire heating device 6, which heats the filler wire X with the heat generated by applying the electric current to the filler wire X, comprises a heating electric-source device 31, a nozzle connecting cable 32 which connects the heating electric-source device 31 and the wire feeding nozzle 11, and a clamp connecting cable 33 which connects the heating electric-source device 31 and one of the plural clamps 5 . . . 5. The electric current from the heating electric-source device 31 is configured to return to the heading electric-source device 31 by way of the nozzle connecting cable 32, the nozzle 11, the filler wire X, the metal plates W1, W2, the clamp 5, the clamp connecting cable 33. Herein, the flowing direction of the electric current may be set to be opposite to the above.

Further, as shown in FIG. 2, the laser welding apparatus 1 according to the present embodiment comprises a control unit 7 which executes the welding control and an image picking-up device 8 which is fixed to the support member 21 of the moving device 4 and picks up an image of a laser-beam irradiated portion L of the work W and its vicinity from above.

The image picking-up device 8 is comprised of a CCD camera which picks up an image in a specified cycle, for example, and the image picked up is outputted to the control unit 7 at each time. Herein, a lamp 9 which illuminates the laser-beam irradiated portion L of the upper metal plate W1 and its vicinity is provided at the support member 21 of the moving device 4. This lamp 9 is arranged on the opposite side to the image picking-up device 8 relative to a welding path R to illuminate the laser-beam irradiated portion L of the upper metal plate W1 and its vicinity from above obliquely. The xenon lamp may be used as the lamp 9.

The control unit 7 analyses the image inputted at each time and based on this analysis result outputs an output control signal to the laser head 2, a rotational-speed control signal to the motor 24 of the moving device 4, and a rotational-speed control signal to the motor 15 of the filler-wire feeding device 10, respectively.

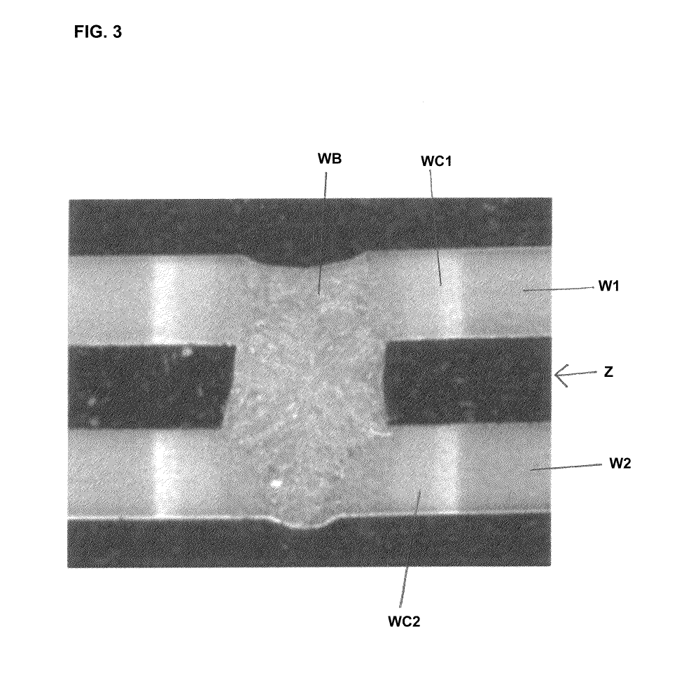

FIG. 3 is a photograph (one example) showing a section of the work in a state in which a proper welding strength is obtained in case the two metal plates W1, W2 with the clearance Z therebetween are welded by feeding the filler wire X. As apparent from this photograph, these metal plates W1, W2 are connected via a bead WB which is formed of a molten metal Wy which has solidified. Further, on the right and left sides of the bead WB exist heat-influence portions WC1, WC2 where some change in the metal structure occurs at the upper and lower metal plates W1, W2 (a whitish color-changed portion on the both sides of the bead WB). Herein, FIG. 3 shows an example in which the thickness of the metal plates W1, W2 is 1.6 mm, the clearance Z is 1.3 mm, the laser output is 6 kw, the diameter of laser beams is 0.6 mm, the diameter of the filler wire X is 0.9 mm, the feeding speed of the filler wire X is 9.5 m/min, and the welding speed is 1.5 m.

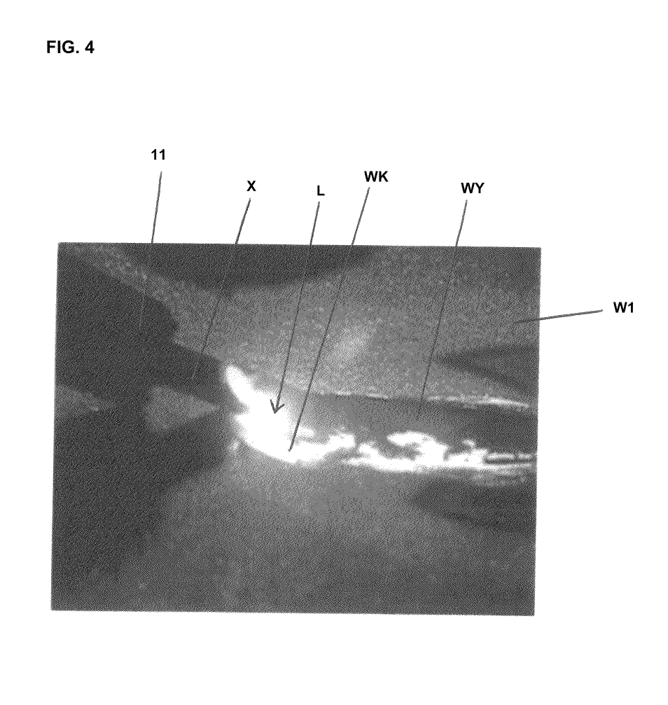

The inventors of the present invention obtained the visible image (animation) shown in FIG. 4 which shows the laser-beam irradiated portion L of the work W shown in FIG. 1 and its vicinity which was picked up by the image picking-up device 8 during the laser welding, and then analyzed the obtained images. According to this analysis, the welding of the upper and lower metal plates W1, W2 is considered to be conducted as shown in FIGS. 5-7.

At first, briefly explaining referring to FIG. 5, the laser beams LB is irradiated toward the surface (upper face) of the upper metal plate W1 of the overlapped metal plates W1, W2 with the clearance Z therebetween so as to move along the welding path R with moving the laser head 2 as shown by an arrow a and the filler wire X is fed to the laser-beam irradiated portion L of the upper metal plate W1 such that its tip follows the laser beams irradiated in such a manner that the laser-beam irradiated portion L of the upper metal plate W1 is molten such that the molten hole WK which penetrates the upper metal plate W1 vertically is generated and the tip of the filler wire X is molten, so that the molten pool WY in which the molten metal of the upper metal plate W1 and the filler wire X is collected around the molten hole can be generated behind the welding path R in such a manner that the molten metal lowers beyond the clearance Z between the upper and lower metal plates W1, W2. Thereby, the upper and lower metal plates W1, W2 are welded together, and the bead WB which is formed of the molten metal which has solidified is formed behind the molten pool WY.

Specifically speaking, as shown in FIGS. 6A, B and 7A, the metal of the upper metal plate W1 near the center LBc of the laser beams LB on the welding path R is molten so that the molten metal Wy is generated. Meanwhile, at the periphery of the molten metal Wy exists the heat-influence portion WC1 where some change in the metal structure occurs. Herein, WK denotes the molten hole (keyhole), which is formed by the molten metal Wy which has been pushed away toward its periphery with receipt of the pressure of the molten metal in a plasma state by the laser beams LB. Its front portion appears in the figures.

As shown in FIGS. 6A, B and 7B, the molten hole WK penetrates the upper metal plate W1 and reaches the lower metal plate W2 at the laser-beam center LBc on the welding path R. Further, the metal of the lower metal plate W2 near the laser-beam center LBc is also molten so that the molten metal Wy is generated. The molten metal Wy of the upper metal plate W1 lowers to the side of the lower metal plate W2. At the periphery of the molten metal Wy of the lower metal plate W2 exists the heat-influence portion WC2.

As shown in FIGS. 6A, B and 7C, the molten metal Wy of the upper metal plate W1 near a portion behind the laser-beam center LBc on the welding path R lowers further downward, and the upper and lower metal plates W1, W2 are welded together. Herein, this welding portion will be the front portion of the molten pool WY as well.

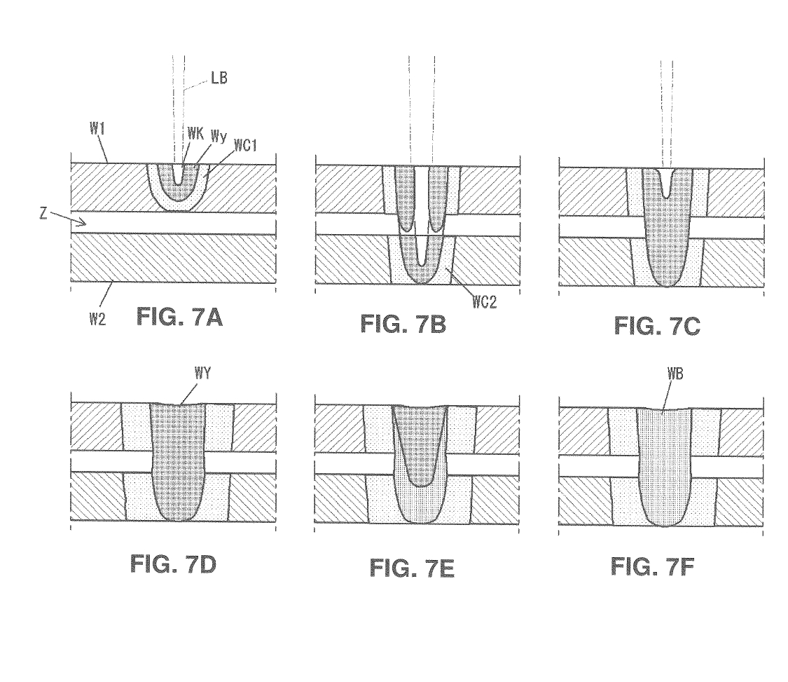

As shown in FIGS. 6B and 7D, the molten pool WY in which the molten metal Wy is collected in the previously-formed molten hole is generated at a portion behind the laser-beam center LBc on the welding path R.

As shown in FIGS. 6B and 7E, the molten metal Wy in the molten pool WY starts solidifying from below at a portion further behind the laser-beam center LBc on the welding path R. At a further rearward portion, the molten metal in a whole area of the molten pool WY has solidified as shown in FIG. 7F.

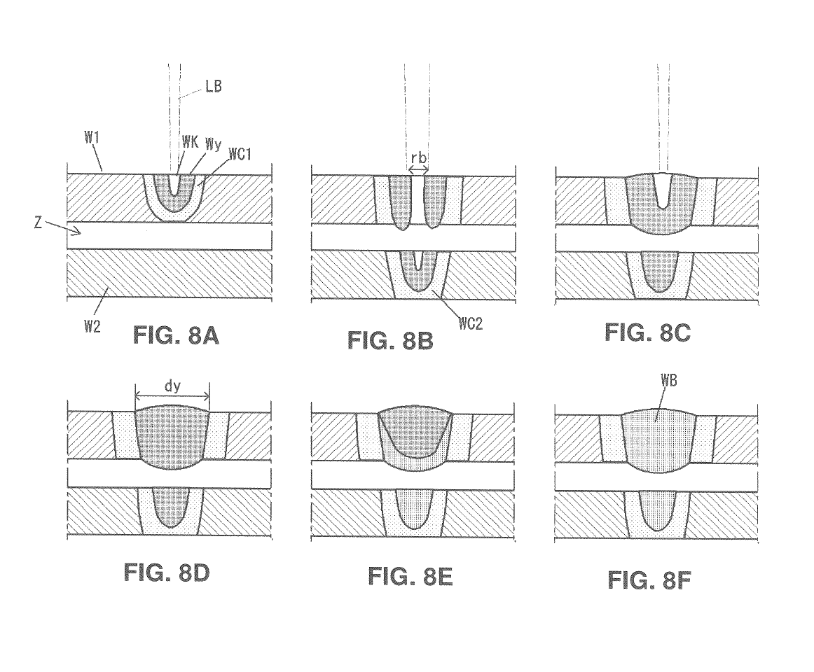

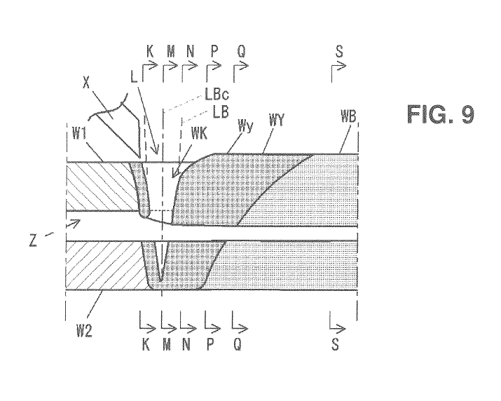

Meanwhile, according to the experiments conducted by the inventors, there was a case in which the upper and lower metal plates W1, W2 were not properly welded together via the bead as shown in FIG. 8F even in case the filler wire X was not fed to the laser-beam irradiated portion L during the welding.

In case of FIG. 8F, compared with the case of FIG. 7F, the clearance Z between the metal plates W1, W2 is greater, and the width of the bead WB of the upper metal plate W1 is considerably greater than that of the bead WB of the lower metal plate W2. FIGS. 8A-E and 9 show the same sectional positions as FIGS. 7A-E and 6A, B, predicting the mechanism of becoming the state of FIG. 8F. Here, there is no substantial difference in the state of the molten metal Wy at the sectional positions shown in FIG. 8A, B, even compared with FIG. 6A, B. However, there are some differences in that at the sectional position C and the others. Herein, the surface tension acts on the molten metal Wy. Accordingly, even if the molten metal Wy of the upper metal plate W1 lowers to a certain degree which is almost the same as the case of FIG. 6A, B, it may not reach (contact) the lower metal plate W2 because the clearance Z between the metal plates W1, W2. Consequently, the heat of the molten metal Wy is necessarily transmitted in the width direction of the upper metal plate W1, so that it may be predicted that the width of the molten pool ZY (molten metal Wy) expands and the width of the bead WB of the upper metal plate W1 is considerably wider than that of the bead WB of the lower metal plate W2 of FIG. 7F.

Herein, the width dy of the molten pool WY is fifth times the diameter rb of the laser beams or greater at the sectional position D. Accordingly, in case the width dy of the molten pool WY is fifth times the diameter rb of the laser beams or greater, it may be predicted that the both metal plates W1, W2 are not welded via the bead WB as shown in FIG. 8F on the contrary.

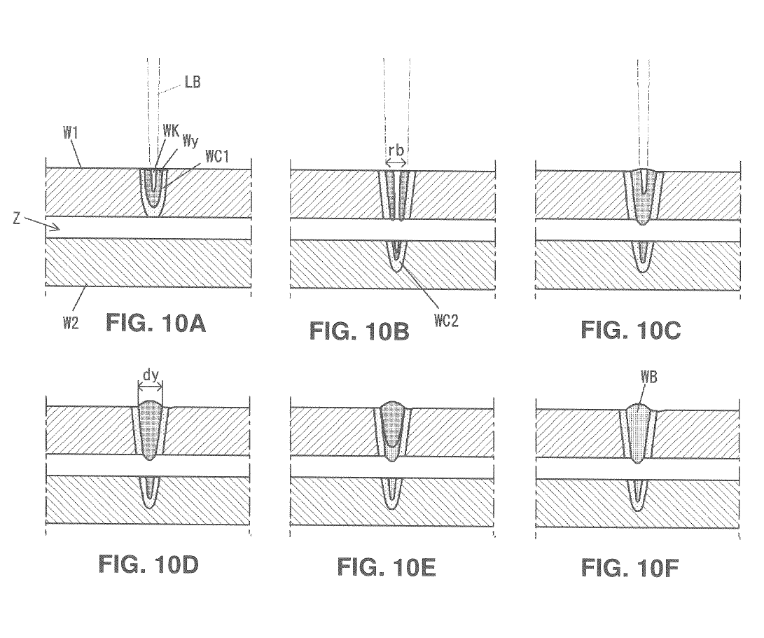

Moreover, according to the experiments conducted by the inventors, there was a case in which the upper and lower metal plates W1, W2 were not welded together as shown in FIG. 10F. In this case, the clearance Z between the metal plates W1, W2 is not different from the case of FIG. 6F very much, however, the width of the bead WB of the upper metal plate W1 and the lower metal plate W2 become less. FIGS. 10A-E show the same sectional positions as FIGS. 6A-E, predicting the mechanism of becoming the state of FIG. 10F. As apparent from FIGS. 10A-F, in the case of FIG. 10F, the width of the molten metal Wy of the upper and lower metal plates W1, W2 has already become small at the sectional positions A, B. The reason for this may be that the energy of the laser beam LB was consumed too much for the melting of the filler wire X so that the heat value to the metal plates W1, W2 become short. Thus, it may be considered that the width dy of the molten pool WY does not expand sufficiently even at the sectional positions C, D and the molten metal Wy does not lower very much, either.

In case of this welding state, the width dy of the molten pool WY is less than twice the laser-beam diameter rb at the sectional position of FIG. 10D. That is, in case the width dy of the molten pool WY is less than twice the laser-beam diameter rb, it may be considered that the both metal plates W1, W2 are not welded via the bead WB.

Accordingly, in the present embodiment, the image of the molten pool WY just behind the molten hole WK is picked up by the picking-up device 8 from the position above the upper metal plate W1, the picked-up image data is analyzed by the control unit 7 to obtain the state of generation (the width dy and so on) of the molten pool WY, it is determined based on this obtained generation state whether the welding state of the metal plates W1, W2 is proper or not, and the welding conditions are adjusted based on the determination result.

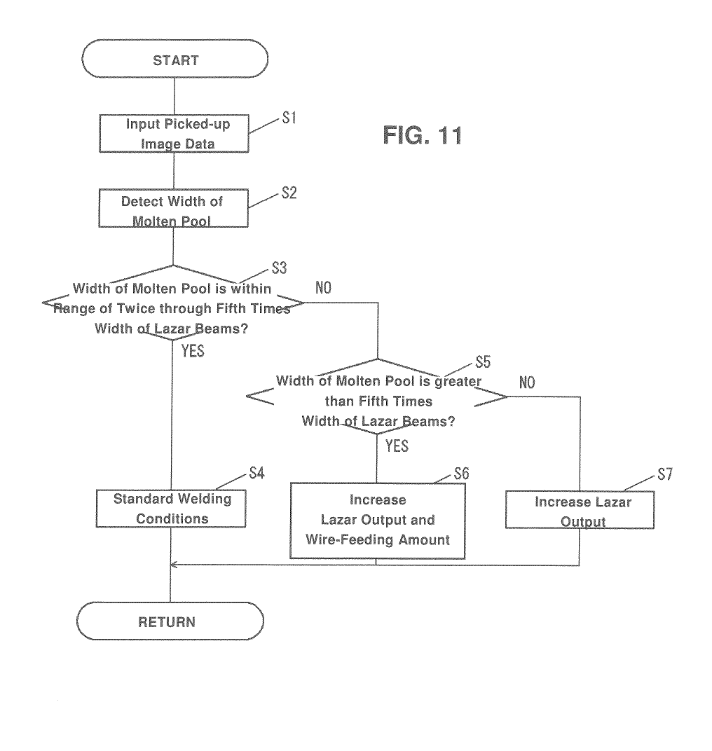

FIG. 11 is an exampled flowchart of the control executed by the control unit 7. The control of this flowchart is executed repeatedly in the specified cycle. For example, an extremely short cycle of 10 ms may be set.

At first, the updated image data from the image picking-up device 8 is inputted in step S1.

In the next step S2, the inputted image data is analyzed, and the width dy of the molten pool WY at the position which is located the specified distance da (see FIG. 6A) behind the laser-beam center LBc on the welding path R is detected. Herein, the specified distance da is set to be so close to the laser-beam center LBc and the molten hole WK that the molten hole WK can surely exist despite a slight change in its length. For example, it is set to be within the range of twice through fifth times the diameter rb (at the surface position of the upper metal plate) of the laser beams LB.

The detection of the molten pool WY of the metal plate W1 may be conducted based on the difference in color or brightness between the surface of the upper metal plate W1 and the molten pool WY, for example. Further, since the temperature of the molten pool WY is considerably higher than that of the other portion, the molten pool WY may be detected by detecting the temperature distribution on the surface of the upper metal plate W1 which is obtained from the image data of the infrared area and then by selecting the high-temperature area which is higher than the melting temperature based on this temperature distribution.

Next, it is determined in step S3 whether or not the width dy of the molten pool WY detected in the step S2 is within the range of twice through fifth times the laser-beam diameter rb. When the width dy of the molten pool WY is within this range (YES), the standard welding conditions are maintained. Meanwhile, when it is not within the above-described range (NO), the control sequence proceeds to step S5.

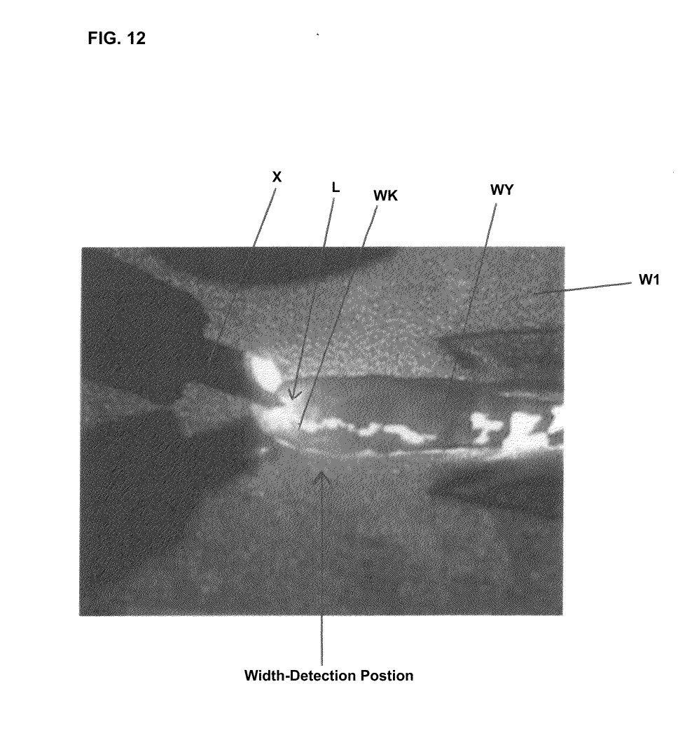

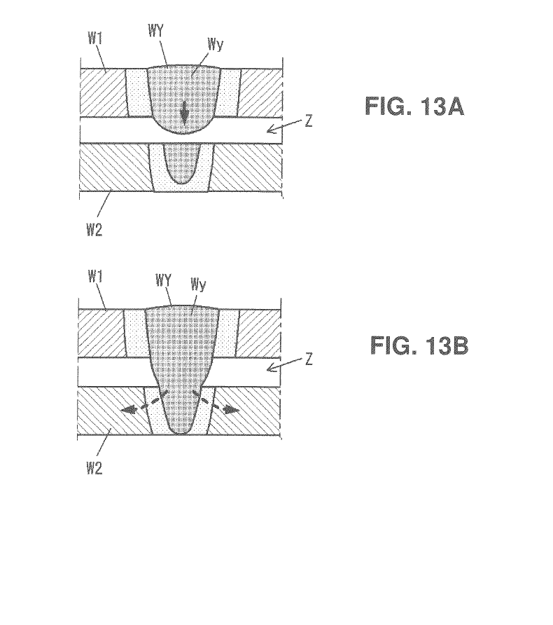

It is determined in step S5 whether the width dy of the molten pool WY is greater than fifth times the laser-beam diameter rb or not. When it is greater than fifth times the laser-beam diameter rb (YES), the laser output is increased and the feeding amount of the filler wire X per unit time is increased as well in step S6. According to the recognition of the inventors, in case the width dy of the molten pool WY is greater than fifth times the laser-beam diameter rb (one example is shown in FIG. 12), the molten metal Wy of the molten pool WY does not lower to the lower metal plate W2 because of the surface tension as shown in FIG. 8D. Therefore, the laser output is increased and the feeding amount of the filler wire X per unit time is increased. Thereby, as shown in FIG. 13A (corresponding to the sectional position of FIG. 8D), the amount of the molten metal Wy increases and the molten metal Wy lowers easily. Further, as shown in FIG. 13B (corresponding to the sectional position of FIG. 8D), the molten metal Wy lowers to the lower metal plate W2 beyond the clearance Z of the metal plates W1, W2, so that it can reach (contact) the molten metal Wy of the lower metal plate W2. Thereby, the temperature of the molten metal Wy transmits to the lower metal plate W2 in the width direction, so that the width of the molten pool WY of the upper metal plate W1 can be made proper (shrink).

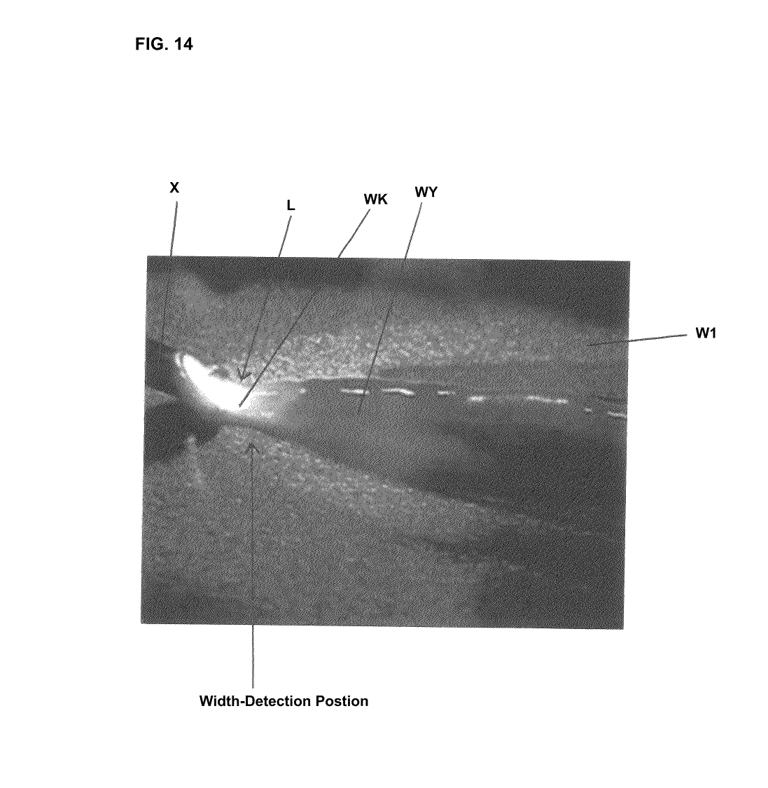

Meanwhile, when it is determined in the step S5 that the width dy of the molten pool WY is not greater than fifth times the laser-beam diameter rb (NO), that is, when the width dy of the molten pool WY is less than twice the laser-beam diameter rb, the laser output is increased in step S6. According to the recognition of the inventors, in case the width dy of the molten pool WY is less than twice the laser-beam diameter rb (one example is shown in FIG. 14), the melting of the upper metal plate W1 is not sufficient because the laser output is consumed too much for melting the filler wire X, so that the metal plates W1, W2 cannot be welded together via the bead WB. Therefore, the laser output is increased. Thereby, the melting of the upper metal plate W1 is promoted and the amount of the molten metal Wy increases. Consequently, the width dy of the molten metal WY expands more than the its state shown in FIG. 10D and lowers downward further. Accordingly, its state proceeds to the one shown in FIG. 7D.

As described above, according to the laser welding apparatus 1 of the present embodiment, the laser beams LB is irradiated toward the surface of the upper metal plate W1 of the metal plates W1, W2 overlapped vertically with the clearance Z therebetween so as to move along the welding path R and the filler wire X is fed to the laser-beam irradiated portion L of the upper metal plate W1 such that its tip follows the irradiated laser beams LB in such a manner that the laser-beam irradiated portion L of the upper metal plate W1 is molten such that the molten hole WK which penetrates the upper metal plate W1 vertically is generated and the tip of the filler wire X is molten. Consequently, the molten pool WY in which the molten metal of the upper metal plate W1 and the filler wire X is collected around the molten hole WY can be generated behind the laser-beam irradiated portion L in such a manner that the molten metal Wy of the upper metal plate W1 and the filler wire X lowers beyond the clearance Z between the upper and lower metal plates W1, W2.

Herein, the image of the molten pool WY near the molten hole WK from the side of the upper metal plate W1 during the execution of the welding is picked up, it is determined whether the welding state of the upper and lower metal plates W1, W2 is proper or not by analyzing the generation state of the molten pool WY based on the image picked up, and at least one of the parameter of the irradiated laser beams LB and the relative speed between the irradiated laser beams LB and the fed filler wire X and the metal plates W1, W2 is adjusted so that the welding state of the upper and lower metal plates W1, W2 becomes proper in case the welding state determined is not proper. In particular, since the generation state of the molten pool WY is detected accurately based on the image picked up and it is determined based on this detected state whether the welding state of the upper and lower metal plates W1, W2 is proper or not according to the present invention, the accurate determination can be executed. Thus, the proper and high-quality welding can be provided. Herein, in case the above-described image picking-up and determination are repeated in a considerably short cycle, the above-described adjustment can be conducted promptly to correct the improper welding state, thereby improving the welding state.

Further, the width dy of the molten pool WY near the molten hole WK is detected based on the above-described picked-up image data, and it is determined that the welding state is not proper in case this width dy is not within the range of twice through fifth times the laser-beam diameter rb. According to the experiments conducted by the inventors, it was found that in case the width dy of the molten pool WY was less than twice the diameter of the laser beams or greater than fifth times the diameter of the laser beams, the molten metal Wy of the upper metal plate W1 did not lower to the lower metal plate, so that the proper welding of the upper and lower metal plates could not be provided. According to the present embodiment, however, the above-described adjustment is conducted in this case, so that the welding state can be improved.

Moreover, while the check of the welding portion of the welded work was conventionally conducted by cutting the work or putting a cold chisel into the work, this conventional checking might waste the work. According to the present invention, however, the adjustment is conducted almost at the real time depending on the situation detected during the welding, so that the improper welding of the work can be prevented, and the above-described checking by cutting the work or putting the cold chisel into the work can be made unnecessary.

### Embodiment 2

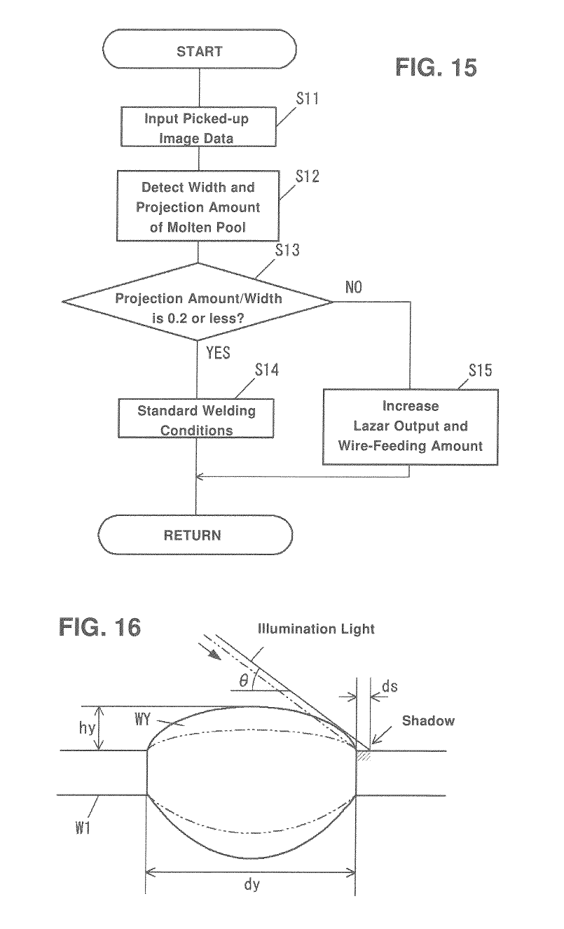

A second embodiment will be described. In the above-described first embodiment, it is determined whether or not the welding state of the upper and lower metal plates W1, W2 is proper by determining whether or not the width dy of the molten pool WY is within the range of twice through fifth times the laser-beam diameter rb. In the second embodiment, however, it is determined whether the welding state of the upper and lower metal plates W1, W2 is proper or not based on the ratio of the amount of projection hy and the width dy of the molten pool WY. Hereinafter, the present embodiment will be described referring to a flowchart of FIG. 15.

At first, the updated image data obtained by the image picking-up device 8 is inputted in step S11.

In the next step S12, the inputted image data is analyzed, and the width dy of the molten pool WY at the position which is located the specified distance da behind the laser-beam center LBc and the amount of projection hy of the molten metal in the molten pool WY over the surface of the upper metal plate W1 are detected. Herein, the specified distance da is set in the same manner as the first embodiment. Further, the detection of the width dy of the molten pool WY is conducted in the same manner as the first embodiment. Meanwhile, the projection amount hy of the molten pool WY is obtained geometrically or by using the data base based on the width ds of a shadow formed beside the molten pool WY by the illumination light of the lamp 9, the width dy of the molten pool WY, and the angle θ between the illumination light of the lamp 9 and the surface of the upper metal plate W1.

In the next step S13, it is determined whether or not the ratio which is obtained by dividing the projection amount hy of the molten pool WY by the width dy of the molten pool WY is 0.2 or less. When the ratio is 0.2 or less (YES), the standard conditions of welding are maintained in step S14. Meanwhile, when the ratio is greater than 0.2 (NO), the control sequence proceeds to step S15.

In the step S15, the laser output is increased and the feeding amount of the filler wire X per unit time is increased. According to the recognition of the inventors, in case the ratio obtained by dividing the projection amount hy of the molten pool WY by the width dy of the molten pool WY is greater than 0.2, the molten metal Wy of the molten pool WY dose not lower to the lower metal plate due to the surface tension, so that the proper welding of the upper and lower metal plates W1, W2 via the bead WB cannot be provided. Therefore, like the step S5 of the above-described first embodiment, the laser output is increased and the feeding amount of the filler wire X per unit time is increased. Consequently, the amount of the molten metal Wy can be increased and the molten metal Wy can be made lower downward easily.

According to the second embodiment, like the first embodiment, the molten metal Wy of the upper metal plate W1 and the filler wire X can be made lower to the lower metal plate W2 beyond the clearance Z, so that the upper and lower metal plates W1, W2 can be surely welded, thereby improving the welding quality.

### Embodiment 3

A third embodiment will be described. In the third embodiment, the detecting method of the projection amount hy of the molten pool WY in the second embodiment is changed. That is, according to the present embodiment, a laser measuring device is attached to the moving device 4. This laser measuring device emits the laser beams to the molten pool WY and receives the reflected beams. Thereby, the projection amount hy of the molten pool WY is detectable. Herein, the flowchart of the present embodiment is the same as that of the above-described second embodiment. According to the third embodiment, the projection amount hy of the molten pool WY can be detected accurately, so that the accuracy of the determination of the welding state of the two metal plates W1, W2 can be improved.

### Embodiment 4

A fourth embodiment will be described. In the fourth embodiment, it is further determined in the third embodiment whether or not the ratio which is obtained by dividing the projection amount hy of the molten pool WY by the width dy of the molten pool WY is −0.1 or less. According to the recognition of the inventors, in case the ratio obtained by dividing the projection amount hy of the molten pool WY by the width dy of the molten pool WY is −0.1 or less, that is, in case the upper face of the molten pool WY is considerably concave, there is a concern that the welding strength would become weak. The reason for this is considered that even if the molten metal Wy lowers to the lower meal plate W2, the clearance Z is great and thereby the amount of the molten metal would be short, so that the upper face of the molten pool WY would become considerably concave. Therefore, in this case, the laser output is increased and the feeding amount of the filler wire X per unit time is increased. Accordingly, the amount of the molten metal Wy is increased so that the ratio obtained by dividing the projection amount hy of the molten pool WY by the width dy of the molten pool WY can become greater than −0.1.

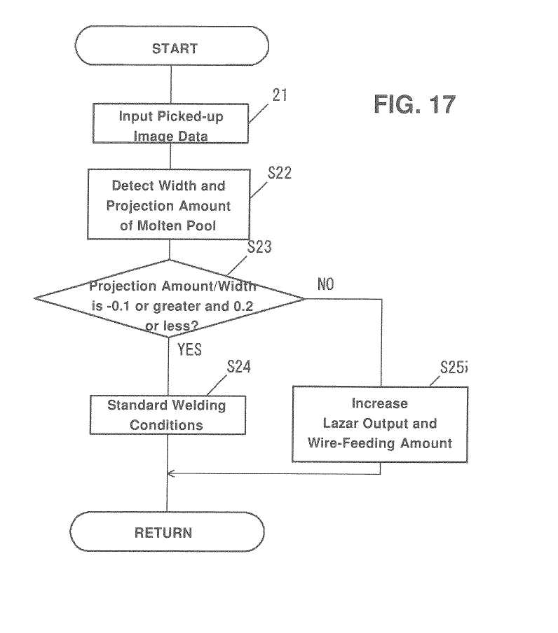

FIG. 17 is an exemplified flowchart of this control. The controls in steps S21, S22 are the same as those in the steps S11, S12 of FIG. 15. Herein, the detection of the projection amount hy of the molten pool WY is used by the laser measuring device similar to the one of the third embodiment. This is because the laser measuring device may detect the concave amount of the molten pool WY.

In the next step S23, it is determined whether or not the ratio which is obtained by dividing the projection amount hy of the molten pool WY by the width dy of the molten pool WY is within a range of −0.1 or greater and 0.2 or less. When the ratio is within this range, the standard conditions of welding are maintained in step S24. Meanwhile, when the ratio is out of this range, the control sequence proceeds to step S25, where the laser output is increased and the feeding amount of the filler wire X per unit time is increased like the second and third embodiments. Thus, any problem caused by the cases in which the ratio obtained by dividing the projection amount hy of the molten pool WY by the width dy of the molten pool WY is less than −0.1 or greater than 0.2 can be solved properly.

While the laser output is increased in the above-described first through fourth embodiments, the welding speed (the relative moving speed between the laser beams and the upper and lower metal plates) may be decreased instead of the increase of the laser output. Thereby, while the welding speed becomes slower, the heat feeding amount per unit to the metal plates W1, W2 increases, so that the similar advantages to those described above can be provided. In this case, the feeding speed of the filler wire X may be changed proportionally.

Further, while a pair of metal plates which have the U-shaped cross section and the flanges overlapped is used as the work in the above-described embodiments, the present invention can be applied to any work having a different shape as long as the image of the surface of the upper metal plate W1 can be picked up.

The present invention should not be limited to the above-descried embodiment, and any other modifications and improvements may be applied within the scope of a sprit of the present invention.

1. A laser welding method of a pair of flat-plate-shaped metal plates overlapped vertically with a clearance therebetween, comprising:
a step of welding upper and lower metal plates overlapped with laser beams and a filler wire, in which the laser beams is irradiated toward a surface of the upper metal plate so as to move along a welding path and the filler wire is fed to a laser-beam irradiated portion of the upper metal plate such that a tip thereof follows the laser beams irradiated in such a manner that the laser-beam irradiated portion of the upper metal plate is molten such that a molten hole which penetrates the upper metal plate vertically is generated and the tip of the filler wire is molten, so that a molten pool in which molten metal of the upper metal plate and the filler wire is collected around the molten hole can be generated behind the laser-beam irradiated portion in such a manner that the molten metal of the upper metal plate and the filler wire lowers beyond the clearance between the upper and lower metal plates;
a step of picking up an image of the molten pool near the molten hole from the side of the upper metal plate during an execution of said welding step;
a step of determining whether a welding state of the upper and lower metal plates is proper or not by analyzing a generation state of the molten pool based on the image picked up in said picking-up step; and
a step of adjusting at least one of a parameter of the irradiated laser beams, a relative speed between the irradiated laser beams and the fed filler wire and the metal plates, and a feeding speed of the filler wire so that the welding state of the upper and lower metal plates becomes proper in case the welding state determined in said determining step is not proper.

2. The laser welding method of claim 1, wherein it is determined in said determining step that the welding state of the upper and lower metal plates is not proper in case the width of the molten pool which is detected based on the image picked up in said picking-up step is not within a range of twice through fifth times the diameter of the laser beams irradiated on the surface of the upper metal plate.

3. The laser welding method of claim 1, wherein it is determined in said determining step that the welding state of the upper and lower metal plates is not proper in case a ratio which is obtained by dividing the amount of projection of the molten metal in the molten pool over the surface of the upper metal plate by the width of the molten pool is greater than 0.2, the amount of projection of the molten metal in the molten pool and the width of the molten pool being detected based on the image picked up in said picking-up step.

4. A laser welding apparatus of a pair of flat-plate-shaped metal plates overlapped vertically with a clearance therebetween, comprising:
means for welding upper and lower metal plates overlapped with laser beams and a filler wire, in which the laser beams is irradiated toward a surface of the upper metal plate so as to move along a welding path and the filler wire is fed to a laser-beam irradiated portion of the upper metal plate such that a tip thereof follows the laser beams irradiated in such a manner that the laser-beam irradiated portion of the upper metal plate is molten such that a molten hole which penetrates the upper metal plate vertically is generated and the tip of the filler wire is molten, so that a molten pool in which molten metal of the upper metal plate and the filler wire is collected around the molten hole can be generated behind the laser-beam irradiated portion in such a manner that the molten metal of the upper metal plate and the filler wire lowers beyond the clearance between the upper and lower metal plates;
means for picking up an image of the molten pool near the molten hole from the side of the upper metal plate during a welding execution by said welding means;
means for determining whether a welding state of the upper and lower metal plates is proper or not by analyzing a generation state of the molten pool based on the image picked up by said picking-up means; and
means for adjusting at least one of a parameter of the irradiated laser beams, a relative speed between the irradiated laser beams and the fed filler wire and the metal plates, and a feeding speed of the filler wire so that the welding state of the upper and lower metal plates becomes proper in case the welding state determined by said determining means is not proper.
